(19) United States
(12) Patent Application Publication
(10) Pub. No.: US 2010/0116949 A1
(43) Pub. Date: May 13, 2010

(54) SUPPORT BRACKET ASSEMBLY FOR AN UPRIGHT COMPUTER CASING

(76) Inventor: Sven Ernst Wagner, Johannesburg (ZA)

Correspondence Address: Emerson, Thomson & Bennett, LLC, 777 W. Market Street, Akron, OH, 44303, US

(21) Appl. No.: 12/514,885

(22) PCT Filed: Nov. 14, 2006
(86) PCT No.: PCT/IB2006/003193

§ 371 Date: May 14, 2009

(51) Int. Cl. F16M 11/04

(52) U.S. Cl. 248/125.8

(57) ABSTRACT

A support bracket assembly for an upright computer casing (12) is provided in which an operatively generally horizontal support platform (1) is supported at the lower end of a lower upright suspension member (2) and an upper operatively upright suspension member member (3) forming together with the lower suspension member a composite suspension member has an attachment unit (4) at its upper end for attachment to a desk (5) or the like. One suspension member is of generally squat tubular configuration receiving the other of the elongate suspension members telescopically therein. Preferably, the outer suspension member has two oppositely disposed series of formations (11) spaced apart in the direction in which the platform extends from the suspension members and both are that engaged simultaneously by stop means (6) associated with the inner suspension member. The stop means is preferably and upright rotatable worm gear (6).

### FIELD OF THE INVENTION

This invention relates to a support bracket accessory for an upright computer casing of the type that is independent of any associated keyboard or monitor and that is typically, although not necessarily, a vertically orientated tower style of casing such as one of the well-known mini-tower casing, midi-tower casing or even a full tower casing.

More particularly, the invention relates to a support bracket assembly that facilitates enhanced utilisation of available space and that can also be used to enhance security of a computer that is supported by it.

### BACKGROUND TO THE INVENTION

Computers housed in tower style of casings are accompanied by the problem that they occupy valuable desktop or workstation space in the event that they are placed on a work top on which a computer is being used, in such event, are also rather unsightly. Alternatively, they occupy valuable floor space if placed on the floor in the immediate vicinity of the relevant desk or workstation. More particularly, if placed on the floor, the result is often also aesthetically displeasing and such a location exposes the computer casing to possible damage from impacts imparted on the casing by persons in the vicinity or by cleaning equipment used to clean the surrounding floor.

There have been proposals, accordingly, to provide a bracket whereby a computer casing can be suspended beneath a desk or other work top so that it is out of the way, easily accessible, and secure. One such proposal is described in published international patent application publication number WO 00/74535 in the name of ACCURIDE INTERNATIONAL INC. Another proposal is described in my own international patent application publication number WO2005/088184.

The difficulty with these earlier proposals, as far as applicant can determine, is that the elongate upright telescopically movable supports that overlap to different extents exhibit unacceptable flexibility when they are made of economical materials such as injection moulded plastics materials. Flexing of the elongate members could lead to a computer casing not being held in an adequately stable manner.

### OBJECT OF THE INVENTION

It is accordingly an object of this invention to provide a support bracket assembly for an upright computer casing that will provide the advantages indicated above yet exhibit enhanced stability.

### SUMMARY OF THE INVENTION

In accordance with this invention there is provided a support bracket assembly for an upright computer casing, the assembly comprising an operatively generally horizontal support platform for supporting the weight of a computer casing thereon in an elevated position relative to the floor, wherein the support platform is supported at the lower end of a lower operatively upright elongate suspension member, an upper operatively upright elongate suspension member forming together with the lower suspension member a composite suspension member, an attachment unit at the upper end of the upper suspension member whereby the assembly may be attached to a desk or the like to suspend the support platform in an elevated position, and wherein the distance between the attachment unit and support platform is adjustable by virtue of the upper and lower suspension members being telescopically adjustable relative to each other, the accessory being characterised in that one of the elongate suspension members, the outer suspension member, is of generally squat tubular configuration receiving the other of the elongate suspension members, the inner suspension member, telescopically therein.

Further features of the invention provide for the outer suspension member to have two oppositely disposed series of formations spaced apart in the direction in which the platform extends from the suspension members; for formations of both of said series of formations to be engaged simultaneously by stop means associated with the inner suspension member; for the stop means to be an upright rotatable worm gear held longitudinally captive relative to the inner suspension member and cooperating with both of said two oppositely disposed series of formations on the outer suspension member; and for the worm gear to be rotatable manually by way of a rotatable operating wheel accessible on an exposed surface of the platform.

Still further features of the invention provide for the attachment unit to assume the form of an attachment panel for securing in particular to the horizontal under-surface of an associated desk or the like with the attachment panel being directed downwards towards the support platform, in use; for the platform and attachment unit to be provided with friction affording pads for engaging the bottom and top of a computer casing in a manner enhancing security by inhibiting and substantially preventing removal of the computer from the support bracket assembly without releasing the means for adjusting the length of the composite suspension member; for the means for adjusting the length of the composite suspension member to be lockable either directly or indirectly by means of a lockable cover operatively preventing access to the adjustment means; and for the platform to have a laterally adjustable upstanding retainer for cooperation with the side of a computer casing opposite the suspension members, in use.

In order that the above and other features of the invention may be more fully understood one embodiment thereof will now be described with reference to the accompanying drawings.

### BRIEF DESCRIPTION OF THE DRAWINGS

In the drawings:

FIG. 1 is a side view of one embodiment of support bracket assembly according to the invention;

FIG. 2 is a front view thereof;

FIG. 3 is a perspective view thereof;

FIG. 4 is an exploded perspective view illustrating the working components thereof;

FIG. 5 is a schematic front elevation showing the support bracket assembly in use;

FIG. 6 is an exploded version of the illustration of FIG. 5;

FIG. 7 is a side view of the installation of FIG. 5 taken from the side at which the suspension members are located; and,

FIG. 8 is a side view of the installation from the side opposite that of FIG. 7.

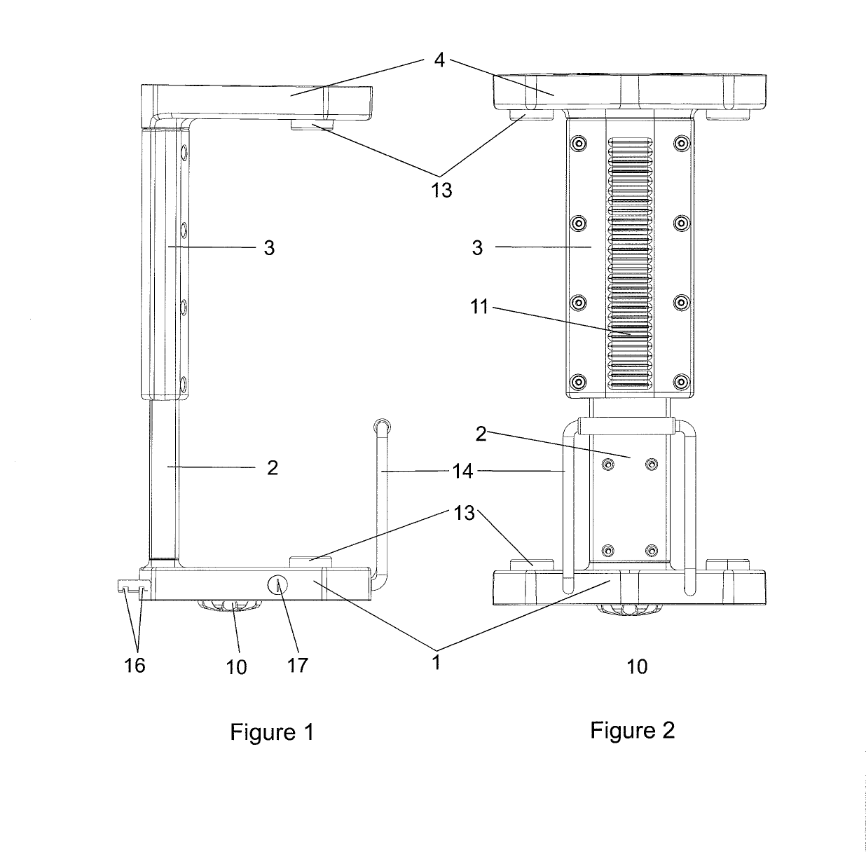

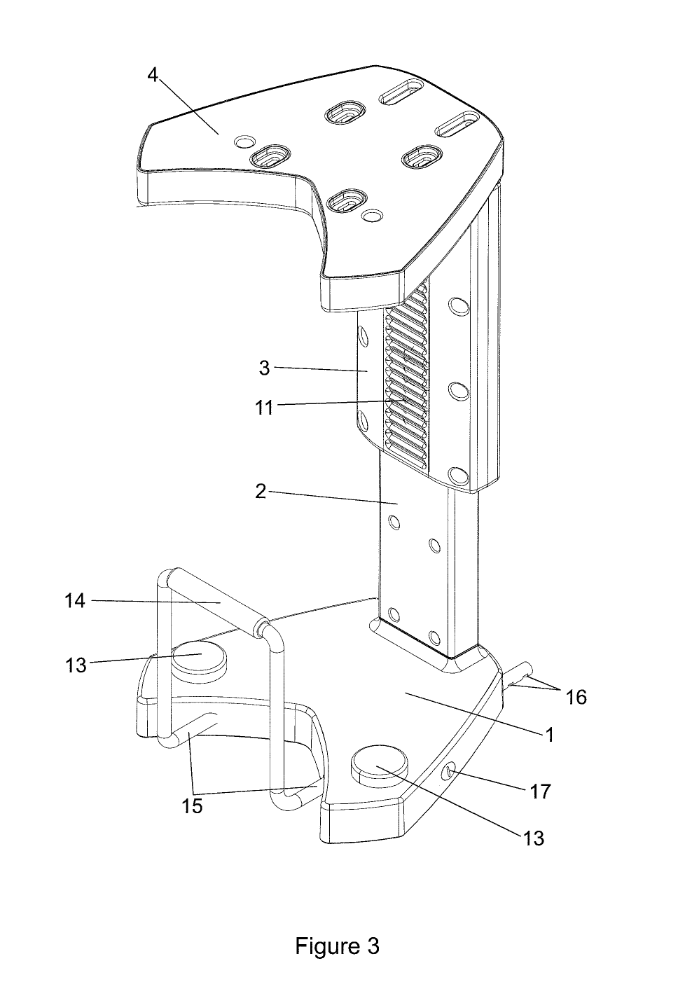

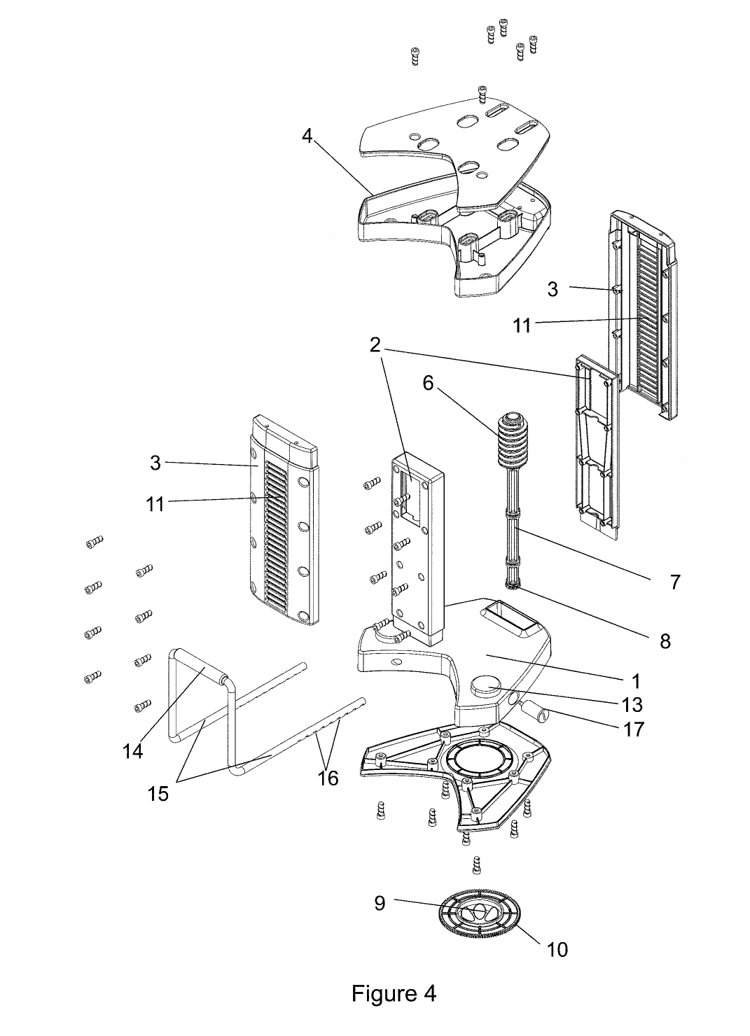

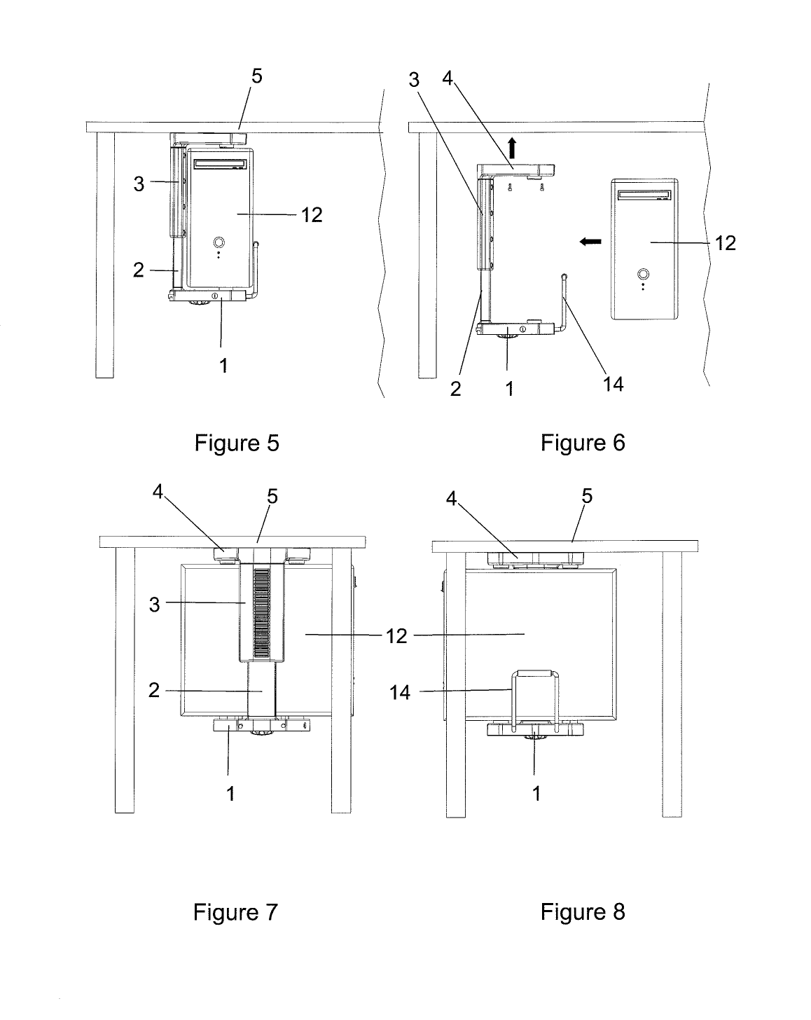

### DETAILED DESCRIPTION WITH REFERENCE TO THE DRAWINGS

In the embodiment of the invention illustrated in the drawings the support bracket assembly is made primarily of injection moulded plastics components although it will be understood that any other appropriate materials, such as pressed metal components, could be used with appropriate variations to the construction detail.

In this embodiment of the invention the support bracket assembly comprises a support platform (1) that is operatively horizontal and that is fixed, at one lateral extremity thereof, to the lower end of an operatively upright lower elongate suspension member (2) extending upwards therefrom. The lower suspension member is hollow, being made of a pair of cooperating injection moulded shells and forms the inner suspension member that is telescopically received within a vertically downwardly extending upper elongate suspension member, the outer suspension member (3), that is carried at its upper end by a transverse attachment unit in the form of an attachment panel (4).

The attachment panel is configured to be secured, typically using fasteners such as screws, to the undersurface of a desktop or other work top (5). Each of the support platform and attachment panel are also made as two cooperating injection moulded shells in order to provide them with suitable rigidity and strength whilst maintaining economy of weight and materials employed.

The outer suspension member (3) is also made of a pair of oppositely directed injection moulded shells that together define a squat tubular configuration that telescopically receives the inner suspension member (2). In this manner an effectively rigid telescopically extensible composite suspension member is formed.

In order to enable telescopic adjustment of the effective length of the composite suspension member, the inner suspension member houses an axially captive but rotatable worm gear (6) that is formed on, or secured to, a longitudinally (that is vertically) extending axle (7) that extends downwards into the platform where it is attached to the inner (that is lower) suspension member. The lower end of the axle has formed integral therewith a gear (8) that meshes with a manually rotatable operating gear (9) having a finger grip (10) associated therewith. The finger grip is thus located on the underside of the platform with the rotatable operating gear being located within the two shells that form the platform.

The outer suspension member has two oppositely disposed series of formations (11) extending along the length thereof and that are operatively engaged simultaneously by two diametrically opposite sides of the worm gear. The two series of formations are thus spaced apart in the direction in which the platform extends from the composite suspension member and this construction provides considerable rigidity to the composite suspension member. Simple and effective adjustment of the distance between the attachment panel and support platform is thereby provided such that a computer casing, indicated by numeral (12) can be effectively clamped between them.

In order to enhance the clamping action, the platform and attachment panel are each provided with friction affording pads (13) for engaging the bottom and top of a computer casing in a manner enhancing security by inhibiting and substantially preventing removal of the computer from the support bracket assembly without releasing the clamping action.

In order to further enhance security and retention of a computer casing in its operative position, the platform has a laterally adjustable upstanding inverted U-shaped retainer (14) for cooperation with the side of a computer casing opposite the composite suspension member. The inverted U-shaped retainer is formed integral with a pair of generally horizontal laterally extending carrier legs (15) that are adjustably received in passages in the platform. Each of the arms has a series of the notches (16) formed therein and, once installed, a removable key operated pin lock (17) can be installed to prevent the retainer from being removed. The combined effect is that it is substantially impossible to remove a computer from the support bracket assembly once it has been installed thereon, without destroying some part of the installation, and typically damaging the computer.

Nevertheless, security can be still further enhanced, if required, by causing the manually operable gear wheel to become locked and therefore prevent, or at least inhibit, release of the clamping action between the support platform and attachment panel. This is achieved by causing the inner end of the pin of the pin lock to pass through a notch in the relevant leg (15) and engage in between two adjacent teeth of the manually rotatable operating gear (9) in the locked condition. In this manner, unauthorised release a computer operatively clamped in the support bracket accessory is effectively inhibited, if not prevented.

It will be understood that the support bracket assembly described above can be mounted by way of fasteners to any suitable downwardly directed horizontal surface so that a computer supported thereby can be effectively stowed in a position that is neither on a worktop of a workstation or desk nor on the floor in the vicinity thereof. Also, security of the support bracket assembly is considerable in that removal of a computer casing from such a support bracket in which has been properly installed is extremely difficult.

Numerous variations may be made to the embodiment of the invention described above without departing from the scope hereof.

1. A support bracket assembly for an upright computer casing, the assembly comprising an operatively generally horizontal support platform for supporting the weight of a computer casing thereon in an elevated position relative to the floor, wherein the support platform is supported at the lower end of a composite suspension member comprising a lower operatively upright elongate suspension member and an upper operatively upright elongate suspension member and an attachment unit at the upper end of the upper suspension member whereby the assembly may be attached to a desk or the like to suspend the support platform in an elevated position,
wherein the distance between the attachment unit and support platform is adjustable by virtue of the upper and lower suspension members being telescopically adjustable relative to each other, with one of the elongate suspension members being an outer suspension member of generally squat tubular configuration receiving the other of the elongate suspension members being the inner suspension member, telescopically therein;
wherein the outer suspension member has two oppositely disposed series of formations spaced apart in the direction in which the platform extends from the suspension members and
wherein the formations of both of said series of formations are engaged simultaneously by stop means associated with the inner suspension member.

2. (canceled)

3. (canceled)

4. A support bracket assembly as claimed in claim 1 in which the stop means is an upright rotatable worm gear held longitudinally captive relative to the inner suspension member and cooperating simultaneously with formations of both of said two oppositely disposed series of formations on the outer suspension member.

5. A support bracket assembly as claimed in claim 4 in which the worm gear is carried at an upper end of an axle rotatable manually by way of a rotatable operating wheel accessible at the undersurface of the platform.

6. A support bracket assembly as claimed in claim 1 in which the attachment unit assumes the form of an attachment panel for securing to a horizontal under-surface of an associated desk or the like with the attachment panel being directed downwards towards the support platform, in use.

7. A support bracket assembly as claimed in claim 1 in which the platform and attachment unit are provided with friction affording pads for engaging the bottom and top of a computer casing.

8. A support bracket assembly as claimed in claim 1 in which the platform has a laterally adjustable upstanding retainer for cooperation with the side of a computer casing opposite the suspension members, in use.

9. A support bracket assembly as in claim 8 in which the laterally adjustable upstanding retainer is formed integral with a pair of generally horizontal laterally extending carrier legs that are adjustably received in passages in the platform.

10. A support bracket assembly as in claim 9 in which for the carrier legs each have a series of notches therein and locking means are provided for locking at least one of the legs relative to the platform by cooperation with a selected notch.
